(19) United States
(12) Patent Application Publication
(10) Pub. No.: US 2009/0260709 A1
(43) Pub. Date: Oct. 22, 2009

(54) Bulb actuated suction device with improved assembly and cleaning features

(76) Inventors: Timothy Corcoran Repp, Pleasant Valley, CT (US); Ellis N. Shamoon, Dalls, TX (US)

Correspondence Address: Daniel V. Thompson;Thompson & Gustavson, LLP, 9304 Forest Lane, Suite N253, Dallas, TX, 75243, US

(21) Appl. No.: 12/425,344

(22) Filed: Apr. 16, 2009

Related U.S. Application Data
(60) Provisional application No. 61/124,272, filed on Apr. 16, 2008.

(51) Int. Cl. A47J 37/10

(52) U.S. Cl. 141/26; 99/345; 141/352

(57) ABSTRACT

A device for transferring viscous liquids includes a flexible bulb with an oversized opening and smooth, relatively flat interior surfaces, coupled to a rigid tapered tube which has an oversized large opening that couples with the flexible bulb. The oversized openings of the flexible bulb and rigid tube make the interior surfaces of these components more easily accessible for cleaning.

### CROSS-REFERENCE TO RELATED APPLICATION

This is a non-provisional application based on U.S. Provisional Patent Application Ser. No. 61/124,272 filed on Apr. 16, 2008.

### FIELD OF THE INVENTION

The invention described herein is a novel improvement to a well known cooking accessory. More particularly, it is a bulb actuated suction device that is easier to assemble, disassemble, and clean.

### BACKGROUND OF THE INVENTION

Bulb actuated suction devices have been used by cooks for many years for basting poultry as well as for transferring viscous liquids from one vessel to another. Prior art shows an abundance of bulb actuated suction devices, which are derived from early eyedropper designs usually consisting of a tapered rigid tube and a flexible bulb. At one end is a large opening while the opposing end tapers to a narrow spout. Affixed in an airtight fashion to the large opening end of the structure is a removable flexible bulb. With one hand the user typically squeezes the flexible bulb and then submerses the small end of the tapered rigid tube into a volume of viscous liquid. Grip pressure is then reduced on the flexible bulb allowing it to expand to its original shape thus creating suction which draws a portion of the liquid into the tapered rigid tube. The user then expels the liquid to its desired location by again squeezing the flexible bulb.

Drawbacks of existing embodiments of this cooks accessory become evident when they are disassembled for cleaning—neither the flexible bulb nor the rigid tube is easy to clean manually or via dishwasher. The flexible bulb is typically formed as a shape with drastically undercut interior surfaces that are difficult for manual cleaning implements or a dishwasher's high temperature water jets to reach. The interior surfaces of such long, tapered rigid tubes as described here are in themselves nearly impossible to clean thoroughly without using a specialized brush. For these reasons it is not uncommon for cooks to avoid using the tool unless absolutely necessary, reducing its overall usefulness. There is a need then, for a bulb actuated suction device that employs features that allow it to become more functional and easier to clean.

The present invention provides a solution to these problems in the form of a flexible bulb with an oversized opening and smooth, relatively flat interior surfaces, coupled to a rigid tapered tube which has an oversized large opening that couples with the flexible bulb. The oversized openings of the flexible bulb and rigid tube make the interior surfaces of these components more easily accessible for cleaning. The ideal embodiment incorporates a retaining ring which couples with the flexible bulb opening, and the couples with the large opening end of the tapered rigid tube by means of a hinge or latch. Other equivalent methods of coupling the flexible bulb with the tapered rigid tube are possible, and it is not intended to limit this invention to any particular means of coupling the two components.

### BRIEF DESCRIPTION OF THE DRAWINGS

A more complete understanding of the invention and its advantages will be apparent from a review of the Detailed Description in conjunction with the following Drawings, in which:

FIG. 1 is a perspective view of a Bulb actuated suction device with improved assembly and cleaning features.

FIG. 2 is a front view of the Bulb actuated suction device with improved assembly and cleaning features of FIG. 1.

FIG. 3 is a rear view of the Bulb actuated suction device with improved assembly and cleaning features of FIG. 1.

FIG. 4 is a left side view of the Bulb actuated suction device with improved assembly and cleaning features of FIG. 1.

FIG. 5 is a right side view of the Bulb actuated suction device with improved assembly and cleaning features of FIG. 1.

FIG. 6 is a top view of the Bulb actuated suction device with improved assembly and cleaning features of FIG. 1.

FIG. 7 is a bottom view of the Bulb actuated suction device with improved assembly and cleaning features of FIG. 1.

### DETAILED DESCRIPTION

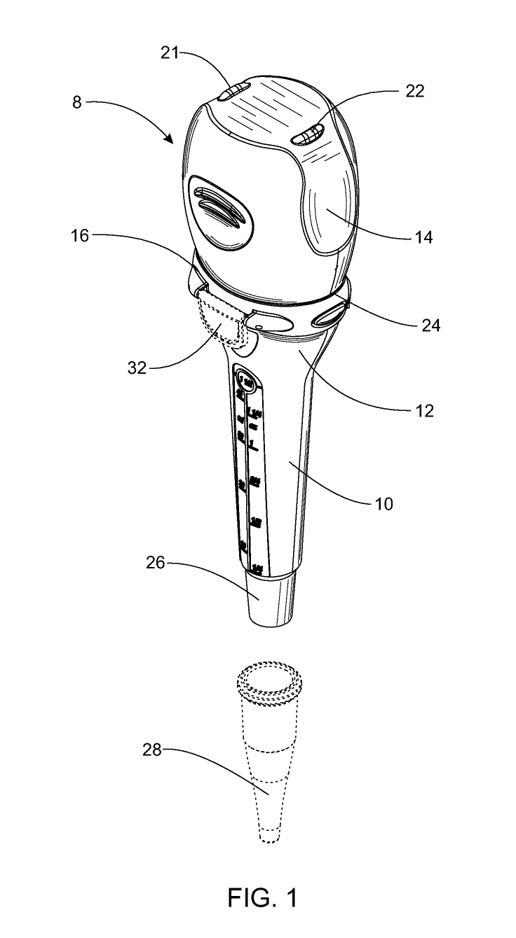

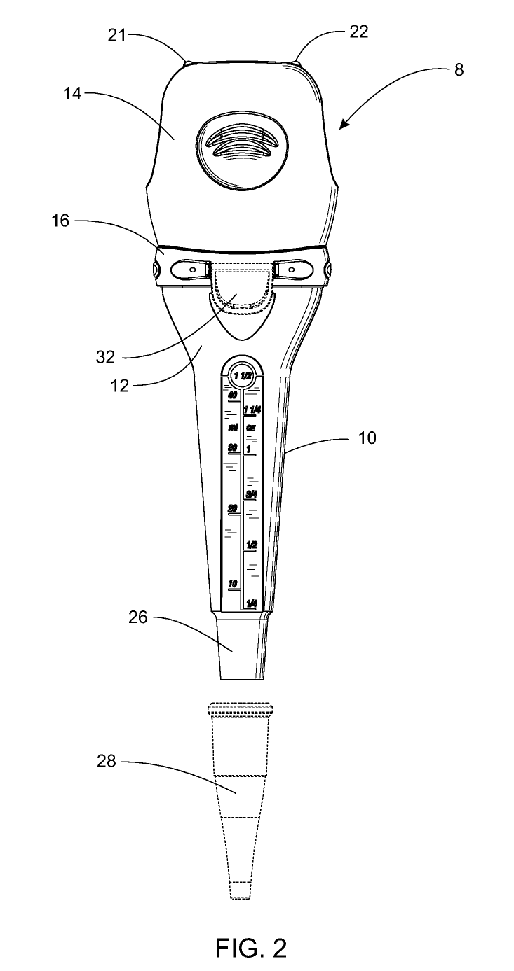

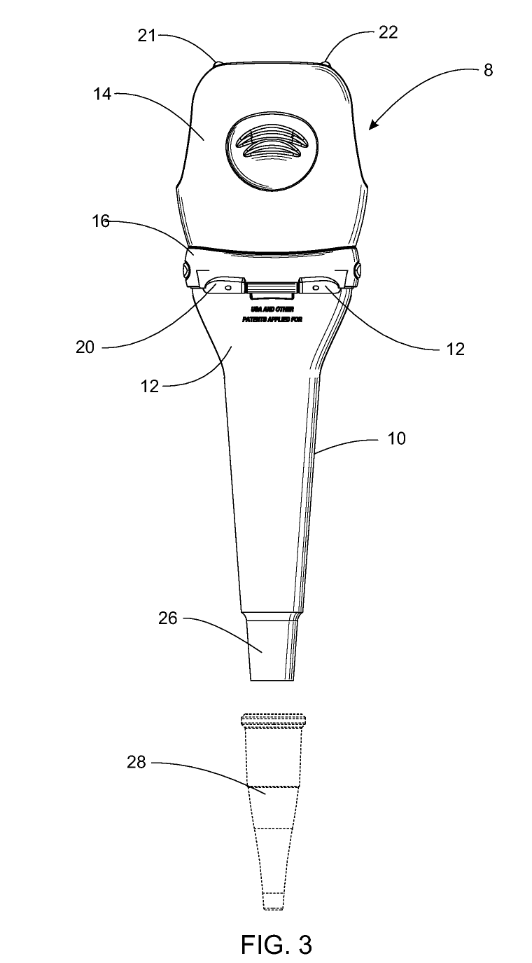

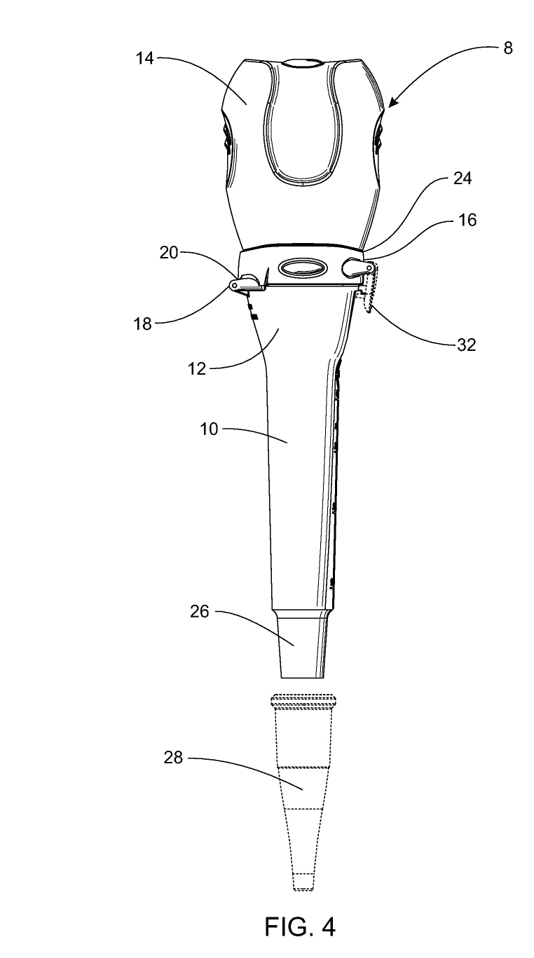

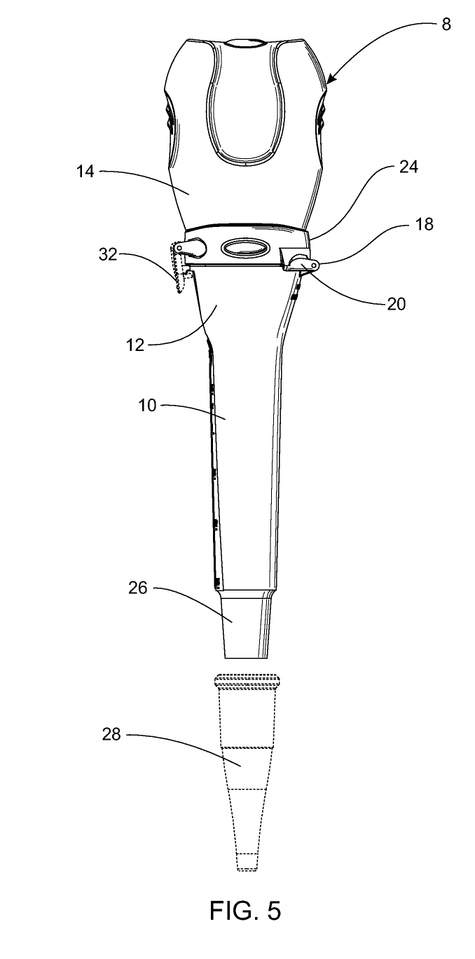

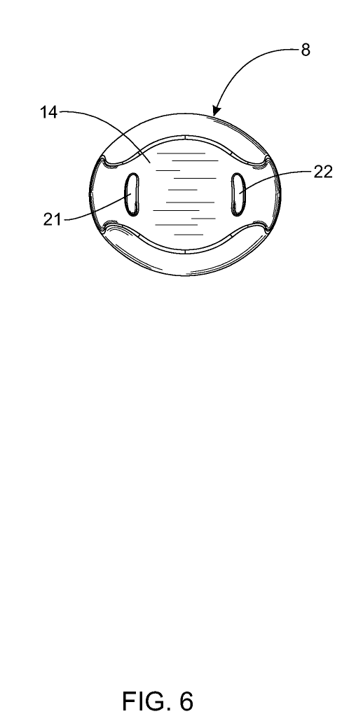

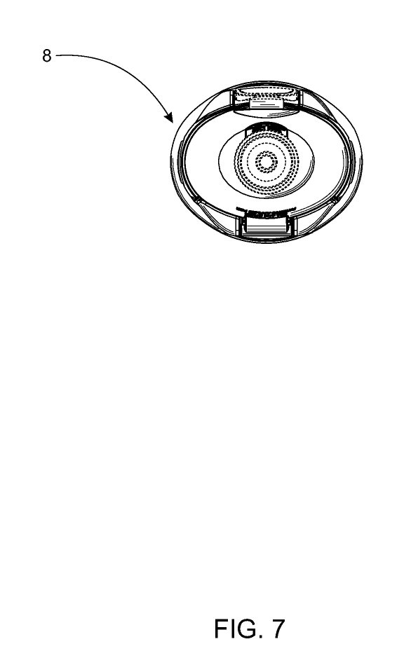

Referring initially to FIGS. 1-7, where like numerals indicate like and corresponding elements, the Bulb actuated suction device with improved assembly and cleaning features 8 incorporates a tapered rigid tube 10. Its larger end 12 has a more voluminous aperture than prior art devices. It is elliptical in cross section, intentionally shaped as such to expose interior surfaces for ease of cleaning while its form translates the same benefit to the flexible bulb 14. The flexible bulb 14, having no drastically undercut interior surfaces, is affixed to a hinged retainer ring 16 that communicates with said tapered rigid tube 10 at the larger end 12. The hinged retainer ring 16 rotates about a lateral hinge pin 18 (FIG. 3). This allows quick and easy access for cleaning and also prevents the flexible bulb 14 from being lost. The hinge body 20 (FIG. 3, 4) is also intended to provide an anti roll feature when the device is laid on a flat surface, and the flexible bulb 14 incorporates a plurality of raised surfaces 21, 22 which allow the device to stand upright when placed on a flat surface. When closed, the hinged retainer ring 16 provides an airtight snap fit at the larger end 12 of the tapered rigid tube 10 and the open end of the flexible bulb 24 utilizing the rubber like properties of the flexible bulb 14. The smaller end of the tapered rigid tube 26 communicates in an airtight fashion with the spout attachment 28. The exaggerated length of the spout attachment 28 allows the tapered rigid tube 10 to be shorter in length, thus much easier to clean when the parts are disassembled. Although a common spout tip is shown and described here, this device is intended to accept other attachments that will broaden its usefulness.

The gist of this invention centers around two key features: a) improved proportions—the tapered rigid tube 10 being proportionally shorter than known prior art, but having a larger aperture 12 for easier manual or dishwasher cleaning that communicates with the larger aperture of the flexible bulb 24 sharing the same benefit. b) improved assembly—a hinged flexible bulb (14, 16, 18, 20) that won't be lost which allows quick assembly and disassembly of the product. And though it is meant to fully describe the invention as portrayed here, it can be reasonably assumed that those skilled in the art could modify or alter certain aspects of this invention without departing from its original spirit.

Materials and fabrication can be, but are not limited to: injection or compression molded plastics such as elastomer, silicone, polycarbonate, nylon.

In operation, the device functions much like prior art solutions until cleanup is required. After use, the user lifts the release clip 32 on the front of the retainer ring 16 and hinges the attached flexible bulb 14 open 180 degrees. Then, the spout attachment 28 is removed. Ideally all parts can be placed in a dishwasher requiring no manual cleaning. After washing, the spout is either re-attached to the tapered rigid tube 10 or placed inside the tapered rigid tube for compact storage. The hinged retainer ring 16 and flexible bulb 14 are rotated back into an airtight closed position snapping securely to the tapered rigid tube (FIG. 1).

What is claimed is:

1. A baster comprising:
a tube having a first open end and a second open end, the tube defining an internal passage extending therebetween, wherein the first tube end defines a restricted opening in communication with the internal passage and the second tube end defines a restricted opening in communication with the internal passage; and
a flexible bulb removably mounted to the tube second end, wherein the flexible bulb defines an open forward end and an internal cavity, the open forward end and internal cavity being of approximately the same circumference as the second tube end; wherein the flexible bulb defines a closed rearward end.

2. The baster of claim 1, wherein the flexible bulb is non-spherical in cross-section.

3. The baster of claim 2, wherein the flexible bulb open forward end and second tube end enlarged opening are elliptical in cross section.

4. The baster of claim 1, wherein the flexible bulb closed rearward end has a plurality of raised surfaces which extend to a flat cross sectional planar area.

5. The baster of claim 1, wherein the distance between the closed rearward end and open forward end of the flexible bulb is greater than one third the distance between the first and second tube ends.

6. The baster of claim 1, wherein the flexible bulb is affixed to a retainer ring that communicates with the second tube end.

7. The baster of claim 6, wherein the retainer ring communicates with the second tube end by means of a hinge or latch, wherein the hinge or latch protrudes substantially from the tube.

8. A baster comprising:
a tube having a first open end and a second open end, the tube defining an internal passage extending therebetween, wherein the first tube end defines a restricted opening in communication with the internal passage and the second tube end defines a restricted opening in communication with the internal passage; and
a flexible bulb removably mounted to the tube second end, wherein the flexible bulb defines an open forward end and an internal cavity, the open forward end and internal cavity being of approximately the same circumference as the second tube end, and wherein the flexible bulb defines a closed rearward end, the closed rearward end having a plurality of raised surfaces which extend to a flat cross sectional planar area.

9. The baster of claim 8, wherein the flexible bulb is non-spherical in cross-section.

10. The baster of claim 9, wherein the flexible bulb open forward end and second tube end enlarged opening are elliptical in cross section.

11. The baster of claim 8, wherein the distance between the closed rearward end and open forward end of the flexible bulb is greater than one third the distance between the first and second tube ends.

12. The baster of claim 8, wherein the flexible bulb is affixed to a retainer ring that communicates with the second tube end.

13. The baster of claim 12, wherein the retainer ring communicates with the second tube end by means of a hinge or latch, wherein the hinge or latch protrudes substantially from the tube.

14. The baster of claim 8, wherein the flexible bulb closed rearward end has a plurality of raised surfaces which extend to a flat cross sectional planar area.

15. A baster comprising:
a tube having a first open end and a second open end, the tube defining an internal passage extending therebetween, wherein the first tube end defines a restricted opening in communication with the internal passage and the second tube end defines a restricted opening in communication with the internal passage; and
a flexible bulb removably mounted to the tube second end wherein the flexible bulb defines an open forward end and an internal cavity, the open forward end and internal cavity being of approximately the same circumference as the second tube end, and wherein the flexible bulb defines a closed rearward end, wherein the flexible bulb is affixed to a retainer ring that communicates with the second tube end, wherein the retainer ring communicates with the second tube end by means of a hinge or latch, and wherein the hinge or latch protrudes substantially from the tube.

16. The baster of claim 15, wherein the flexible bulb is non-spherical in cross-section.

17. The baster of claim 16, wherein the flexible bulb open forward end and second tube end enlarged opening are elliptical in cross section.

18. The baster of claim 15, wherein the distance between the closed rearward end and open forward end of the flexible bulb is greater than one third the distance between the first and second tube ends.

19. The baster of claim 15, wherein the flexible bulb closed rearward end has a plurality of raised surfaces which extend to a flat cross sectional planar area.

20. A baster comprising:
a tube having a first open end and a second open end, the tube defining an internal passage extending therebetween, wherein the first tube end defines a restricted opening in communication with the internal passage and the second tube end defines a restricted opening in communication with the internal passage; and
a flexible bulb removably mounted to the tube second end, wherein the flexible bulb defines an open forward end and an internal cavity, the open forward end and internal cavity being of approximately the same circumference as the second tube end, and wherein the flexible bulb defines a closed rearward end, wherein the flexible bulb is affixed to a retainer ring that communicates with the second tube end, wherein the retainer ring communicates with the second tube end by means of a hinge or latch, and wherein the hinge or latch protrudes substantially from the tube.
